(19) United States
(12) Patent Application Publication
(10) Pub. No.: US 2004/0040899 A1
(43) Pub. Date: Mar. 4, 2004

(54) Easily collapsible and portable water filtering device

(75) Inventor: Gwo-Sen Wu, Taichung (TW)

Correspondence Address: TROXELL LAW OFFICE PLLC, SUITE 1404, 5205 LEESBURG PIKE, FALLS CHURCH, VA, 22041, US

(73) Assignee: Shuenn Der Shing Industry Co., Ltd.

(21) Appl. No.: 10/419,750

(22) Filed: Apr. 22, 2003

(30) Foreign Application Priority Data
Aug. 28, 2002 (TW) 091213604

(51) Int. Cl. B01D 24/00

(52) U.S. Cl. 210/109; 210/266; 210/452; 210/497.1

(57) ABSTRACT

An easily collapsible and portable water filtering device mainly includes an outer barrel, an inner barrel, a filter unit, a water reserving space and a water dispensing valve. The outer barrel has a rigid first upper frame section and a soft watertight outer bag. The inner barrel has a rigid second upper frame section and a soft watertight inner bag. The filter unit is fixed on a fixing bottom edge of the bottom end of the inner bag. The filter unit contains a replaceable filtering member. The water reserving space can store certain filtered water. So, this invention is easily collapsible, suitable to be used in the wild filed, and can serve as a mini-type water reserving kettle temporarily.

### FIELD OF THE INVENTION

The present invention relates to an easily collapsible and portable water filtering device. Particularly, this invention relates to a water filtering device that can be easily collapsed and carried and can be used in a wild field. Also, the water filtering device can serve as a mini-type water reserving kettle temporarily.

### BACKGROUND OF THE INVENTION

A conventional water filtering device is installed beside a faucet or in a water dispenser. Such water filtering device is fixed and quite cumbersome. It is hard to move to another location.

For a mountaineer or a camper, it is impossible to carry too heavy clean water with him/her. Therefore, it is necessary to find a clean water source in the wild field for cooking or drinking.

In case the found water contains too much mud or impurity and no filtering device is available, the taste of the cooked food, soup or the drink will be poor and even the body will get ill.

Therefore, it is necessary to invent a new personally portable water filtering device usable in a wild field. The mountaineers and campers can use the water filtering device in the wild field to filter water.

### SUMMARY OF THE INVENTION

It is therefore a primary object of the present invention to provide an easily collapsible and portable water filtering device usable in a wild field. Due to its outer and inner bags of the water filtering device are made of soft material and can be easily collapsed to minimize the volume of the water filtering device. Therefore, the water filtering device can be conveniently stored and carried.

It is a further object of the present invention to provide the easily collapsible and portable water filtering device that is suitable to be used in the wild field.

It is a further object of the present invention to provide the easily collapsible and portable water filtering device which also can temporarily serve as a mini-type water reserving kettle.

In order to achieve above objects, the easily collapsible and portable water filtering device comprises:

an outer barrel having a rigid first upper frame section and a soft watertight outer bag, the outer barrel having an opening facing upward, a handle extending from the upper frame section;

an inner barrel having a rigid second upper frame section and a soft watertight inner bag, the inner barrel having another opening facing upward, the second upper frame section being fitted in the first upper frame section with the entire inner barrel positioned in the outer barrel, a bottom end of the inner bag being formed with a fixing bottom edge;

a filter unit fixed on the fixing bottom edge of the bottom end of the inner bag, the filter unit having a water filtering housing formed with a water inlet and a water outlet, a filtering passage being formed between the water inlet and the water outlet, a filtering member being replaceably disposed in the filtering passage;

a water reserving space positioned between a bottom face of the filter unit and an inner bottom face of the outer bag of the outer barrel, the water reserving space having a predetermined capacity for reserving the filtered water; and

a water discharging valve disposed in a predetermined position of a lateral face of the bottom end of the outer bag for controlling discharge of the water from the water reserving space.

The present invention can be best understood through the following description and accompanying drawings wherein:

### BRIEF DESCRIPTION OF THE DRAWINGS

FIG. 1 is a perspective assembled view of the present invention;

FIG. 2 is a sectional assembled view of the present invention;

FIG. 3 is an enlarged sectional view of a part of the present invention;

FIG. 4 is a perspective exploded view of the present invention;

FIG. 5 is a cross-sectional view of the filter unit of the present invention;

FIG. 6 shows that the present invention is mounted on a tripod;

FIG. 7 shows that the present invention is collapsed; and

FIG. 8 shows that the filtering member of the filter unit is detached.

### DETAILED DESCRIPTION OF THE PREFERRED EMBODIMENTS

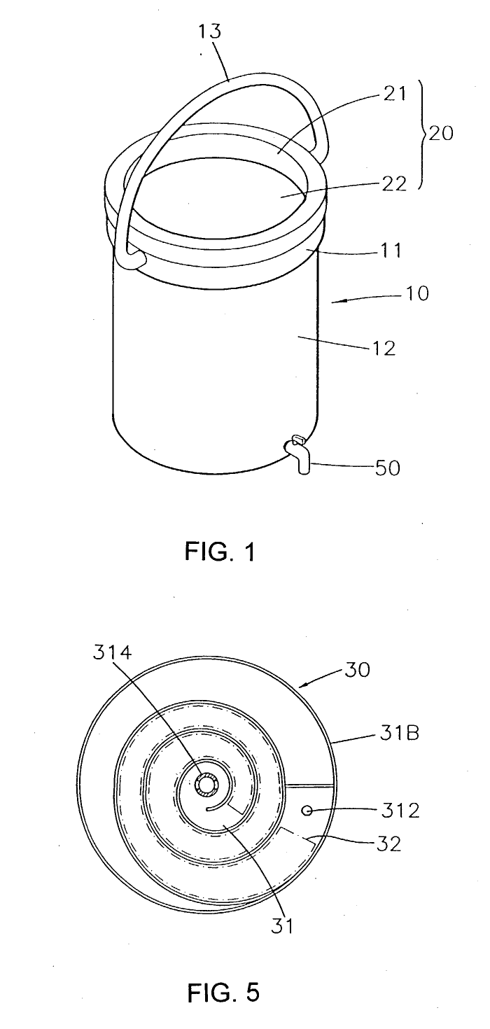

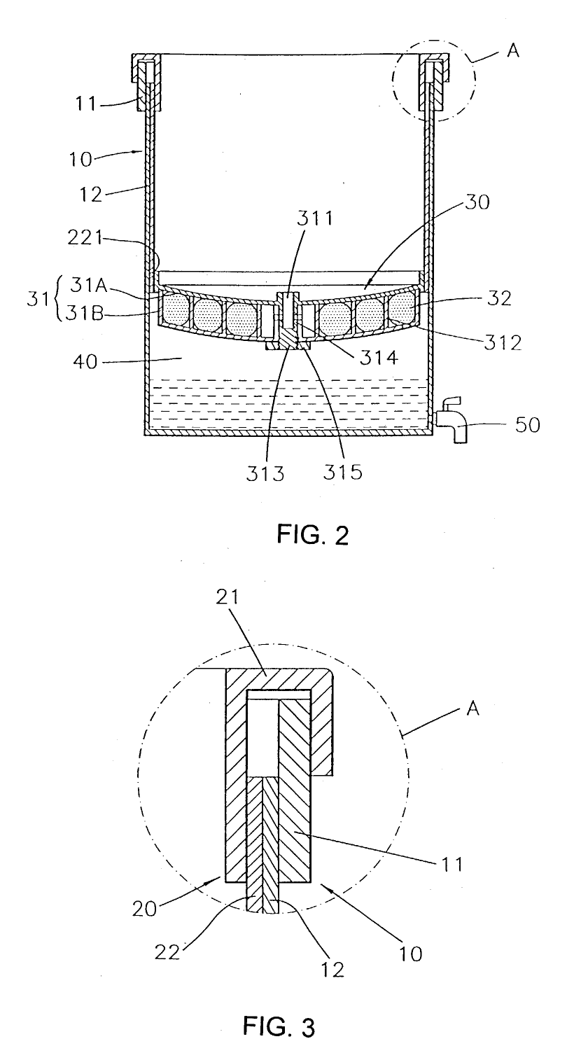

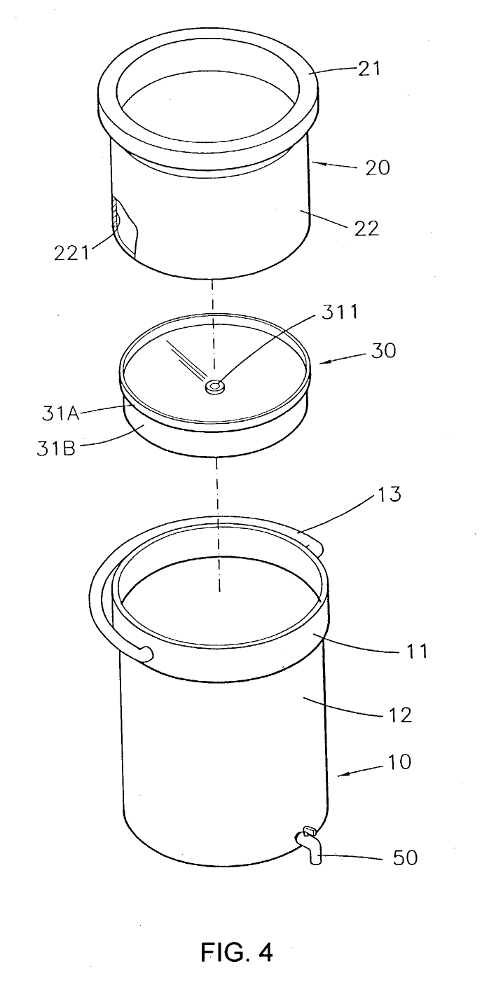

Please refer to FIGS. 1 to 5. The easily collapsible and portable water filtering device of the present invention mainly includes an outer barrel 10, an inner barrel 20, a filter unit 30, a water reserving space 40 and a water dispensing valve 50.

The outer barrel 10 has a rigid first upper frame section 11 (for example, made of metal or acrylic material) and a soft watertight outer bag 12 (for example, made of pliable plastic sheet material). The outer barrel 10 has an opening facing upward. A handle 13 extends from the upper frame section 11.

The inner barrel 20 has a rigid second upper frame section 21 and a soft watertight inner bag 22 (for example, made of soft plastic sheet material). The inner barrel 20 also has an opening facing upward. The second upper frame section 21 is fitted in the first upper frame section 11 with the entire inner barrel 20 positioned in the outer barrel 10. The bottom end of the inner bag 22 is formed with a fixing bottom edge 221.

The filter unit 30 is fixed on the fixing bottom edge 221 of the bottom end of the inner bag 22, whereby the filter unit 30 is integrally connected with the inner barrel 20. The filter unit 30 has a water filtering housing 31 formed with a water inlet 311 and a water outlet 312. A filtering passage (such as the spiral passage as shown in FIG. 5) is formed between the water inlet 311 and the water outlet 312. A filtering member 32 is replaceably disposed in the filtering passage.

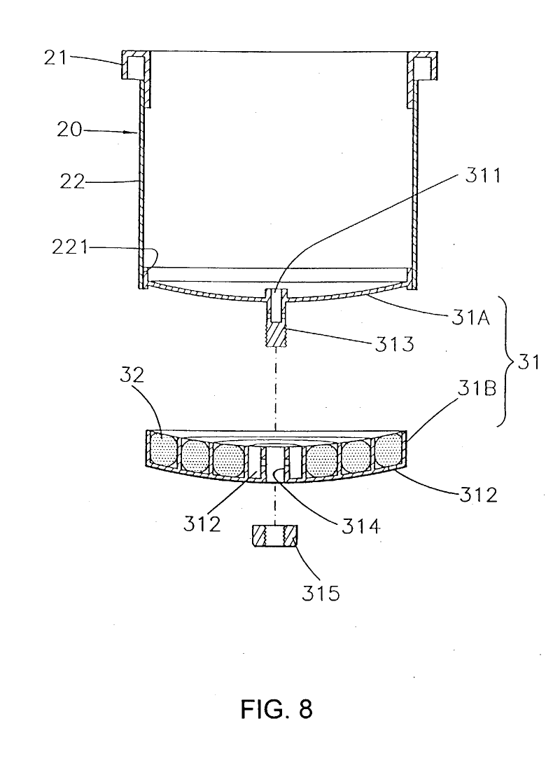

Practically, referring to FIG. 8, in order to periodically replace the filtering member 32, the water filtering housing 31 is preferably composed of two lockable sections than can be locked together or be separated. That is, the water filtering housing 31 includes a top casing 31A (fixed on the fixing bottom edge 221 of the inner bag 22) and a bottom casing 31B. The top casing 31A has a downward extending first fixing section 313 (having a water incoming way). The bottom casing 31B has a second fixing section 314 with which the first fixing section 313 is engaged. The first fixing section 313 is locked by a threaded fixing member 315. Accordingly, after the fixing member 315 is unscrewed, a user can quickly take off the bottom casing 31B to replace the filtering member 32 inside.

The water reserving space 40 is positioned between the bottom face of the filter unit 30 and the inner bottom face of the outer bag 12 of the outer barrel 10. The water reserving space 40 has a predetermined capacity for reserving the filtered water. Also, the water reserving space 40 serves to temporarily reserve water.

The water discharging valve 50 is disposed in a predetermined position of a lateral face of the bottom end of the outer bag 12 for controlling discharge of the water from the water reserving space 40.

Furthermore, as shown in FIG. 5, the filtering passage of the filter unit 30 can be a spiral passage outward spiraling from the circular center. Therefore, the length of the filtering passage can be maximized. Moreover, the filtering member 32 is substantially an elongated member which can be loaded into the filtering passage along the length thereof. In general, the filtering member 32 contains activated carbon and unwoven fabric filtering material. Certainly, other filtering materials can be added to the filtering member 32 or the manner in which the filtering materials are arranged can be changed.

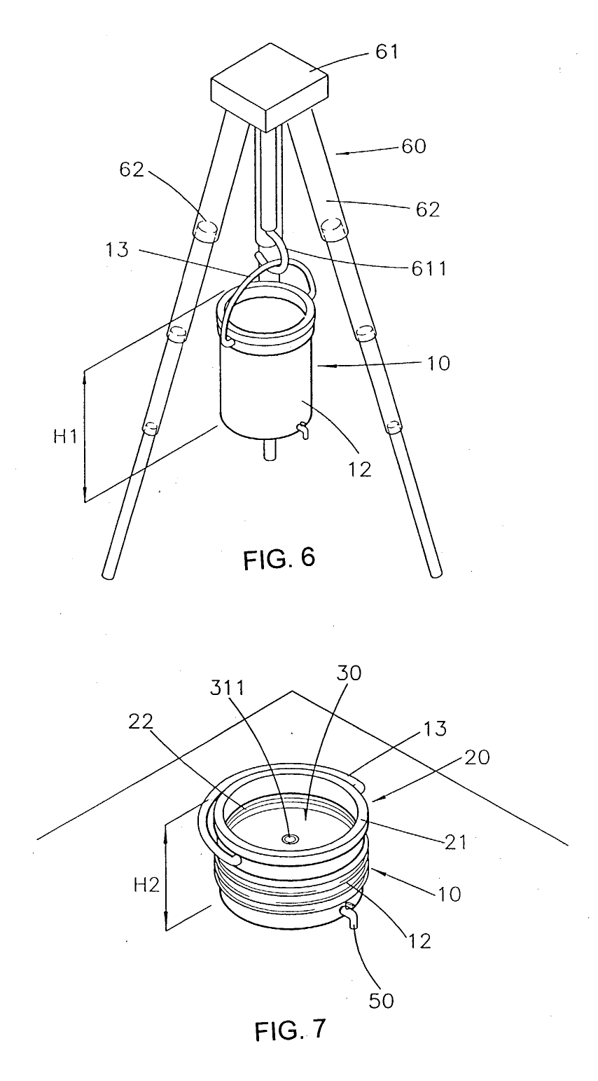

A user can hold the handle 13 of the present invention or hang the handle 13 of the present invention on a tree. Alternatively, as shown in FIG. 6, the present invention can be co-used with a tripod 60 having a top section 61 and three legs 62 downward obliquely extending from the top section 61. The top section 61 is equipped with a hook section 611 for hooking the handle 13 of the outer barrel 10. Accordingly, the present invention can be fixed in a wild field.

The leg 62 can be a telescopic member composed of multiple fitting tubes 621. The fitting tubes 621 can be detached to minimize the volume of the tripod and facilitate carriage thereof.

In practical operation, if a user needs some clean water to cook or drink on a mountain or in a wild field, the user can first build the tripod 60 beside a stream (or a river) and then hang the handle 13 of the outer barrel 10 on the hook section 611 of the tripod 60. Then the stream water is poured into the inner barrel 20 to down flow into the filter unit 30. After the water flows into the water inlet 311, the impurities entrained by the water are filtered off by the filtering member 32 in the filtering passage. The clean water will flow out from the water outlet 312 into the water reserving space 40 which serves as a temporary water reservoir. Simply by means of turn on the water discharging valve 50, the filtered clean water can be discharged.

When transferring the camp to another subject place, the water reserved in the water reserving space 40 is drained out. After the handle 13 is detached from the hook section 611, the outer bag 12 and the inner bag 22 which are made of soft material can be deformed. Accordingly, as shown in FIGS. 6 and 7, the present invention can be compressed from an original height H1 to a collapse height H2 which is about the height of the upper frame section 11 plus the height of the filtering member 30. As shown in FIG. 7, the volume of the present invention is minimized for easy storage.

Therefore, the present invention can be collapsed into a very small volume and placed in a back bag for easy carriage. This is quite convenient for a mountaineer or a camper.

Therefore, the present invention has the following advantages:

1. The present invention can be easily collapsed and carried. The outer and inner bags of the present invention can contain much water. However, the outer and inner bags are soft and can be collapsed to minimize the volume and weight. Therefore, the present invention can be easily placed into a back bag and conveniently carried.

2. The present invention is usable in a wild field. The present invention can be used to quickly filter off the mud, sand and impurity contained in the water source (such as a stream or a river) in a wild field. The quality of the water can be greatly improved for drinking, especially for mountaineers and campers.

3. The present invention can serve as a mini-type water reserving kettle. The water reserving space 40 of the present invention can contain a considerable amount of filtered water for ready use.

The above embodiments are only used to illustrate the present invention, not intended to limit the scope thereof. Many modifications of the above embodiments can be made without departing from the spirit of the present invention.

What is claimed is:

1. A easily collapsible and portable water filtering device comprising:
an outer barrel having a rigid first upper frame section and a soft watertight outer bag, the outer barrel having an opening facing upward, a handle extending from the upper frame section;
an inner barrel having a rigid second upper frame section and a soft watertight inner bag, the inner barrel having another opening facing upward, the second upper frame section being fitted in the first upper frame section with the entire inner barrel positioned in the outer barrel, a bottom end of the inner bag being formed with a fixing bottom edge;
a filter unit fixed on the fixing bottom edge of the bottom end of the inner bag, the filter unit having a water filtering housing formed with a water inlet and a water outlet, a filtering passage being formed between the water inlet and the water outlet, a filtering member being replaceably disposed in the filtering passage;
a water reserving space positioned between a bottom face of the filter unit and an inner bottom face of the outer bag of the outer barrel, the water reserving space having a predetermined capacity for reserving the filtered water; and
a water discharging valve disposed in a predetermined position of a lateral face of the bottom end of the outer bag for controlling discharge of the water from the water reserving space.

2. The easily collapsible and portable water filtering device as claimed in claim 1, wherein the filtering passage of the filter unit is a spiral passage.

3. The easily collapsible and portable water filtering device claimed in claim 1, wherein the water filtering housing includes a top casing and a bottom casing, the top casing having a downward extending first fixing section, the bottom casing having a second fixing section with which the first fixing section is engaged, the first fixing section being locked by a fixing member, whereby a user can quickly take off the bottom casing to replace the filtering member.

4. The easily collapsible and portable water filtering device as claimed in claim 1, wherein the filtering member is substantially an elongated member and contains at least activated carbon and unwoven fabric filtering material.

5. The easily collapsible and portable water filtering device as claimed in claim 1, further comprising a tripod having a top section and three legs downward obliquely extending from the top section, the top section being equipped with a hook section for hooking the handle of the outer barrel.

6. The easily collapsible and portable water filtering device as claimed in claim 5, wherein each leg is a telescopic member composed of multiple fitting tubes.
